(19) United States
(12) Patent Application Publication
(10) Pub. No.: US 2018/0155629 A1
(43) Pub. Date: Jun. 7, 2018

(54) BITUMEN THAT IS SOLID AT AMBIENT TEMPERATURE

(71) Applicant: TOTAL MARKETING SERVICES, Puteaux (FR)

(72) Inventors: Régis VINCENT, Grigny (FR); Mouhamad MOUAZEN, Lyon (FR); Laurence LAPALU, Villeurbanne (FR)

(73) Assignee: TOTAL MARKETING SERVICES, Puteaux (FR)

(21) Appl. No.: 15/735,473

(22) PCT Filed: Jun. 7, 2016
(86) PCT No.: PCT/FR2016/051360

§ 371 Date: Dec. 11, 2017

(30) Foreign Application Priority Data
Jun. 9, 2015 (FR) 1555261

(51) Int. Cl. C10C 3/14; C08K 3/013; C08L 71/02; C08L 95/00; C08L 97/00; C09D 101/00; C09D 103/04; C09D 105/04; C09D 105/12; C09D 189/06; C09D 197/00

(52) U.S. Cl. CPC C10C 3/14; C08K 3/013; C08L 71/02; C08L 95/00; C08L 97/005; B29B 2009/163; C09D 103/04; C09D 105/04; C09D 105/12; C09D 189/06; C09D 197/005; C09D 101/00

(57) ABSTRACT

Granular bitumen that is solid at ambient temperature includes a core and a coating layer that covers all or part of the surface of the core, wherein the core includes at least one bitumen base, and the coating layer includes at least one viscosifying compound and at least one anticaking compound. A method for manufacturing bitumen that is solid at ambient temperature and the use of bitumen that is solid at ambient temperature as a road binder, particularly for manufacturing asphalts. Further, a method for manufacturing asphalts from solid bitumen and to a method for transporting and/or storing road bitumen that is solid at ambient temperature.

### TECHNICAL FIELD

The subject of the present invention is a road bitumen in divided form, which is solid at ambient temperature. The present invention also relates to a process for preparing road bitumen at ambient temperature and also to the use thereof as road binder, in particular for the manufacture of mixes.

The present invention also relates to a process for manufacturing mixes from solid bitumen according to the invention and also to a process for transporting and/or storing road bitumen which is solid at ambient temperature according to the invention.

### PRIOR ART

The vast majority of bitumen is used in construction, mainly for the manufacture of road carriageways or in industry, for example for roofing applications. It is generally in the form of a black material which is highly viscous, or even solid at ambient temperature, and which liquefies when heated.

Generally, bitumen is stored and transported under hot conditions, in bulk, in tanker trucks or by boats at high temperatures of about 120° C. to 160° C. However, the storage and transportation of bitumen under hot conditions has certain drawbacks. Firstly, the transportation of bitumen under hot conditions in liquid form is considered to be dangerous and it is highly restricted from a regulatory point of view. This mode of transportation does not present particular difficulties when the transportation equipment and infrastructures are in good condition. If this is not the case, it can become problematic: if the tanker truck is not sufficiently lagged, the viscosity of the bitumen may increase during an excessively long trip. The bitumen delivery distances are therefore limited. Secondly, maintaining bitumen at high temperatures in tanks or in tanker trucks consumes energy. In addition, maintaining bitumen at high temperatures for a long period of time can affect the properties of the bitumen and thus change the final performance levels of the mix.

In order to overcome the problems of transporting and storing bitumen under hot conditions, packaging allowing the transportation and storage of bitumens at ambient temperature has been developed. This mode of transportation of bitumen in packaging at ambient temperature represents only a minimal fraction of the amounts transported throughout the world, but it corresponds to very real needs for geographic regions which are difficult and expensive to access using conventional transportation means.

By way of example of packaging for transportation under cold conditions, currently used, mention may be made of packaging the bitumen at ambient temperature in metal barrels. This means is increasingly questionable from an environmental point of view since the bitumen stored in the barrels must be reheated before it is used as road binder. However, this operation is difficult to carry out for this type of packaging and the barrels constitute waste after use. Furthermore, the storage of bitumen at ambient temperature in barrels results in losses since the bitumen is very viscous and a part of the product remains on the walls of the barrel when the bitumen is transferred into the tanks of mix production units. With regard to the handling and transportation of bituminous products in these barrels, they can prove to be difficult and dangerous if the specialized equipment for handling the barrels is not available in the transporters or at the site where the bitumen is used.

By way of other examples of packaging, mention may be made of bitumens in the form of pellets transported and/or stored in bags, often used in places where the ambient temperature is high. These pellets have the advantage of being easy to handle. U.S. Pat. No. 3,026,568 describes bitumen pellets covered with a powdery material, such as calcium carbonate powder. Nevertheless, this type of bitumen in the form of pellets does not prevent bitumen creep, in particular at high ambient temperature.

Application WO 2009/153324 describes bitumen pellets coated with a polymeric anti-agglomerating compound, in particular polyethylene. The drawback of this coating is that it modifies the properties of the bitumen when it is used on roads.

Application US 2011/0233105 describes asphalt which is solid at ambient temperature, in the form of pellets comprising a core and a coating layer. The core consists of recycled materials and binder based on asphalt. The coating layer may include one or more water-resistant polymers, a wax or fines. The purpose of this coating layer is to prevent the particles from adhering to one another, but also to adjacent surfaces during storage. This document does not disclose the content of viscosifying compound compared with the total weight of the coating layer. It also does not disclose the viscosity of the compounds which are part of the composition of the coating layer.

The applicant has therefore sought to demonstrate bitumens capable of being subjected to high ambient temperatures without creeping, in particular bitumens in the form of pellets of which the adhesion and agglomeration during transportation and/or storage and/or handling thereof at high ambient temperature is reduced compared with the prior art pellets.

There is therefore a need to provide a road bitumen which can be transported and/or stored and/or handled at ambient temperature, making it possible to overcome the drawbacks of the prior art.

One objective of the present invention is to provide a road bitumen which can be transported and/or stored and/or handled at high ambient temperature, and the properties of which are preserved over time.

In particular, the aim of the present invention is to provide a road bitumen which can be transported and/or stored for a period of greater than 2 months, preferably than 3 months, and at high ambient temperature, in particular at a temperature of less than 100° C., preferably from 20° C. to 80° C.

Another objective of the invention is to provide a road bitumen which can be easily handled, in particular at high ambient temperature, in particular at a temperature ranging up to 100° C., preferably from 20° C. to 80° C.

In particular, the aim of the present invention is to provide a road bitumen which is easy to handle after a prolonged period of transportation and/or storage at high ambient temperature, in particular for a transportation and/or storage period of greater than 2 months, preferably greater than 3 months, and at a temperature ranging up to 100° C., preferably between 20° C. and 80° C.

One objective of the present invention is to provide a road bitumen in a form which allows it to flow in solid form at ambient temperature, so as to be able to handle it without loss of material. It has been sought to provide a road bitumen which is in a form which makes it possible to package it in a packing, to remove it from the packaging, and to transfer it into a piece of equipment, even at a high ambient temperature, without needing to heat it, and without loss of material. The bitumen proposed is in a form which is divided and solid at ambient temperature such that it makes it possible to satisfactorily solve the problems mentioned above.

Another objective is to provide an industrial and economic process for manufacturing road bitumen which can be transported and/or stored at ambient temperature.

Another objective of the invention is to provide an industrial and economic process for manufacturing mixes from road bitumen which can be transported and/or stored at ambient temperature.

Another objective of the invention is to provide an ecological and economic process for transporting and/or storing and/or handling road bitumen at ambient temperature, making it possible to avoid the use of additional means for maintaining the temperature of said bitumen during transportation and/or storage and/or handling and making it possible to minimize the presence of waste and/or of residues.

### SUMMARY OF THE INVENTION

A subject of the invention is a bitumen which is solid at ambient temperature, in the form of pellets comprising a core and a coating layer in which:
the core comprises at least one bitumen base, and
the coating layer comprises at least one viscosifying compound and at least one anti-agglomerating compound.

The invention further relates to a process for manufacturing a bitumen which is solid at ambient temperature, in the form of pellets composed of a core and of a coating layer for the core, this process comprising:
i) forming the core from at least one bitumen base,
ii) coating the core on all or part of its surface with a composition comprising at least one viscosifying compound and at least one anti-agglomerating compound,
iii) optionally, drying the pellets obtained in step ii) at a temperature ranging from 20 to 60° C., for a period ranging from 5 minutes to 5 hours, preferably from 5 minutes to 2 hours.

Preferably, the coating layer comprises at least 10% by weight of one or more viscosifying compounds relative to the total weight of the coating layer.

The invention also relates to a bitumen which is solid at ambient temperature, capable of being obtained by carrying out this process.

According to one preferred embodiment, the viscosifying compound has a dynamic viscosity greater than or equal to 50 mPa·s⁻¹, preferably from 50 mPa·s⁻¹ to 550 mPa·s⁻¹, more preferentially from 80 mPa·s⁻¹ to 450 mPa·s⁻¹, the viscosity being a Brookfield viscosity measured at 65° C.

According to one preferred embodiment, the viscosifying compound is chosen from:
gelling compounds, preferably of plant or animal origin, such a gelatin, agar-agar, alginates, cellulose derivatives, starches, modified starches, and gellan gums;
polyethylene glycols (PEGs) such as PEGs having a molecular weight of between 800 g·mol⁻¹ and 8000 g·mol⁻¹;
mixtures of such compounds.

According to one particularly preferred embodiment, the viscosifying compound is chosen from:
gelling compounds, preferably of plant or animal origin, such as gelatin, agar-agar, alginates, cellulose derivatives, and gellan gums;
polyethylene glycols (PEGs) such as PEGs having a molecular weight of between 800 g·mol⁻¹ and 8000 g·mol⁻¹;
mixtures of such compounds.

According to one preferred embodiment, the coating layer comprises at least 10% by weight of at least one viscosifying compound relative to the total weight of the coating layer, preferably from 10% to 90% by weight, more preferentially from 10% to 85% by weight.

According to one preferred embodiment, the anti-agglomerating compound is chosen from: talc; fines generally with a diameter of less than 125 μm, such as siliceous fines, with the exception of limestone fines; sand such as fontainebleau sand; cement; carbon; wood residues such as lignin, lignosulfate, conifer needle powders, conifer cone powders, notably pine; glass powder; clays such as kaolin, bentonite, vermiculite; alumina such as alumina hydrates; silica; silica derivatives such as silicates, silicon hydroxides and silicon oxides; plastic powder; lime, gypsum; powered rubber; powder of polymers, such as styrene-butadiene (SB) copolymers, styrene-butadiene-styrene (SBS) copolymers; and mixtures thereof.

According to one preferred embodiment, the coating layer comprises at least 10% by weight of at least one anti-agglomerating compound relative to the total weight of the coating layer, preferably from 10% to 90% by weight, even more preferentially from 15% to 90% by weight.

According to one preferred embodiment, the bitumen base has a needle-penetrability measured at 25° C. according to standard EN 1426 of from 5 to 330 1/10 mm, preferably from 20 to 220 1/10 mm.

According to one preferred embodiment, the bitumen base also comprises at least one chemical additive chosen from: an organic compound, a paraffin, a polyphosphoric acid and mixtures thereof.

According to one preferred embodiment, the bitumen base has a penetrability of from 5 to 45 1/10 mm, measured at 25° C. according to standard EN 1426, and/or a ring and ball softening temperature of greater than or equal to 90° C., the ring and ball softening temperature being measured according to standard EN 1427.

According to one preferred embodiment, the bitumen which is solid at ambient temperature has a stability with respect to transportation and storage at a temperature ranging from 20 to 80° C. for a period of greater than or equal to 2 months, preferably greater than or equal to 3 months.

The invention also relates to the use of the solid bitumen defined above, as a road binder.

According to one preferred embodiment, the use relates to the manufacture of mixes.

The invention further relates to a process for manufacturing mixes comprising at least one road binder and aggregates, the road binder being chosen from the bitumens defined above, this process comprising at least the steps of:
heating the aggregates to a temperature ranging from 100° C. to 180° C., preferably from 120° C. to 160° C.,
mixing the aggregates with the road binder in a tank such as a mixer or a mixing drum,
obtaining mixes.

According to one preferred embodiment, the process for manufacturing mixes does not comprise a step of heating the road binder before it is mixed with the aggregates.

Finally, the invention relates to a process for transporting and/or storing road bitumen, said road bitumen being transported and/or stored in the form of bitumen which is solid at ambient temperature as defined above.

### DETAILED DESCRIPTION

The objectives that the applicant set itself have been achieved by virtue of the development of compositions of bitumen in divided form, having a core/envelope structure, in which the core is based on bitumen and the coating layer confers, on the overall structure, improved properties compared with the bitumen pellets known from the prior art.

A first subject of the invention relates to a bitumen which is solid at ambient temperature, in the form of pellets comprising a core and a coating layer in which:
the core comprises at least one bitumen base, and
the coating layer comprises at least one viscosifying compound and at least one anti-agglomerating compound.

The term “ambient temperature” is intended to mean the temperature resulting from the climatic conditions under which the road bitumen is transported and/or stored. More specifically, the ambient temperature is equivalent to the temperature reached during the transportation and/or storage of the road bitumen, it being understood that ambient temperature implies that there is no provision of heat other than that resulting from the climatic conditions.

The invention relates to bitumens capable of being subjected to a high ambient temperature, in particular a temperature ranging up to 100° C., preferably from 20° C. to 80° C.

The term “bitumen which is solid at ambient temperature” is intended to mean a bitumen which has a solid appearance at ambient temperature whatever the transportation and/or storage conditions. More specifically, the term “bitumen which is solid at ambient temperature” is intended to mean a bitumen which retains its solid appearance throughout the transportation and/or storage at ambient temperature, i.e. a bitumen which does not creep at ambient temperature under its own weight and, furthermore, which does not creep when it is subjected to pressure forces resulting from the transportation and/or storage conditions.

The expression “coating layer covering all or part of the surface of the core” is intended to mean that the coating layer covers at least 90% of the surface of the core, preferably at least 95% of the surface of the core, more preferentially at least 99% of the surface of the core.

The expression “consists essentially of” followed by one or more characteristics means that components or steps which do not significantly modify the properties and characteristics of the invention may be included in the process or the material of the invention in addition to the components or steps explicitly listed.

The Viscosifying Compound:

For the purposes of the invention, the terms “viscosifying agent” and “viscosifying compound” are used in an equivalent manner and independently of one another. The term “viscosifying agent” or “viscosifying compound” is intended to mean a compound which has the property of reducing the fluidity of a liquid or of a composition and therefore of increasing the viscosity thereof.

For the purposes of the invention, the viscosifying agent is a material which has a dynamic viscosity of greater than or equal to 50 mPa·s⁻¹, preferably from 50 mPa·s⁻¹ to 550 mPa·s⁻¹, more preferentially from 80 mPa·s⁻¹ to 450 mPa·s⁻¹, the viscosity being a Brookfield viscosity measured at 65° C. The viscosity of a viscosifying agent according to the invention is measured at 65° C. by means of a Brookfield CAP 2000+ viscometer at a rotational speed of 750 rpm. The measurement is read after 30 seconds for each temperature.

Preferably, the viscosifying agent is chosen from:
gelling compounds, preferably of plant or animal origin, such as: belatin, agar-agar, alginates, cellulose derivatives, starches, modified starches, or gellan gums;
polyethylene glycols (PEGs) such as PEGs having a molecular weight of between 800 g·mol⁻¹ and 8000 g·mol⁻¹, for instance a PEG having a molecular weight of 800 g·mol⁻¹ (PEG-800), a PEG having a molecular weight of 1000 g·mol⁻¹ (PEG-1000), a PEG having a molecular weight of 1500 g·mol⁻¹ (PEG-1500), a PEG having a molecular weight of 4000 g·mol⁻¹ (PEG-4000) or a PEG having a molecular weight of 6000 g·mol⁻¹ (PEG-6000);
mixtures of such compounds.

Advantageously, the viscosifying agent is chosen from:
gelling compounds, preferably of plant or animal origin, such as: gelatin, agar-agar, alginates, cellulose derivatives or gellan gums;
polyethylene glycols (PEGs) such as PEGs having a molecular weight of between 800 g·mol⁻¹ and 8000 g·mol⁻¹, for instance a PEG having a molecular weight of 800 g·mol⁻¹ (PEG-800), a PEG having a molecular weight of 1000 g·mol⁻¹ (PEG-1000), a PEG having a molecular weight of 1500 g·mol⁻¹ (PEG-1500), a PEG having a molecular weight of 4000 g·mol⁻¹ (PEG-4000) or a PEG having a molecular weight of 6000 g·mol⁻¹ (PEG-6000);
mixtures of such compounds.

The Anti-Agglomerating Compound:

The anti-agglomerating compound is of mineral or organic origin. The term “anti-agglomerating agent” or “anti-agglomerating compound” is intended to mean any compound which limits, reduces, inhibits or delays the agglomeration and/or the adhesion of the pellets to one another during transportation thereof and/or storage thereof at ambient temperature and which ensures that they are fluid when they are handled.

More preferentially, the anti-agglomerating compound is chosen from: talc, fines, also called “fillers”, generally with a diameter of less than 125 μm, such as siliceous fines, with the exception of limestone fines; sand such as fontainebleau sand; cement; carbon; wood residues such as lignin, lignosulfate, conifer needle powders, conifer cone powders, notably of pine; glass powder; clays such as kaolin, bentonite, vermiculite; alumina such as alumina hydrates; silica; silica derivatives such as silicates, silicon hydroxides and silicon oxides; plastic powder; lime; gypsum; powdered rubber; powder of polymers, such as styrene-butadiene (SB) copolymers, styrene-butadiene-styrene (SBS) copolymers and mixtures of these materials.

Advantageously, the anti-agglomerating compound is chosen from: fines, generally with a diameter of less than 125 μm; wood residues such as lignin, conifer needle powders and conifer cone powders; mixtures thereof.

The Coating Layer:

According to one embodiment of the invention, the coating layer is obtained by applying a composition comprising at least one viscosifying compound and at least one anti-agglomerating compound to all or part of the surface of the solid bitumen core.

Preferably, the coating layer is solid at ambient temperature, including at high ambient temperature.

Preferably, the composition comprising at least one viscosifying compound and at least one anti-agglomerating compound has a viscosity of greater than or equal to 200 mPa·s⁻¹, preferably of between 200 mPa·s⁻¹ and 700 mPa·s⁻¹, the viscosity being a Brookfield viscosity.

Preferentially, the coating layer comprises at least 10% by weight of at least one viscosifying compound relative to the total weight of the coating layer, preferably from 10% to 90% by weight, more preferentially from 10% to 85% by weight.

Advantageously, when the viscosifying agent is a gelling agent, for instance gelatin, the coating layer comprises from 10% to 90% by weight of viscosifying compound relative to the total weight of the coating layer, preferably from 15% to 85%, even better still from 15% to 60%.

Advantageously, when the viscosifying agent is a gelling agent, for instance gelatin, the coating layer comprises from 10% to 90% by weight of anti-agglomerating compound relative to the total weight of the coating layer, preferably from 15% to 85%, even better still from 40% to 85%.

Advantageously, when the viscosifying agent is a PEG, for instance a PEG having a molecular weight of between 800 g·mol⁻¹ and 8000 g·mol⁻¹, the coating layer comprises from 10% to 90% by weight of viscosifying compound relative to the total weight of the coating layer, preferably from 40% to 90%, even better still from 60% to 90%.

Advantageously, when the viscosifying agent is a PEG, for instance a PEG having a molecular weight of between 800 g·mol⁻¹ and 8000 g·mol⁻¹, the coating layer comprises from 10% to 90% by weight of anti-agglomerating compound relative to the total weight of the coating layer, preferably from 10% to 60%, even better still from 10% to 40%.

Preferentially, the coating layer comprises at least 10% by weight of an anti-agglomerating compound relative to the total weight of the coating layer, preferably from 10% to 90% by weight, even more preferentially from 15% to 90% by weight.

Preferably, the coating layer represents at least 5% by weight relative to the total weight of the pellet, preferably from 10% to 60% by weight, more preferentially from 10% to 50%.

In addition to the viscosifying compound and the anti-agglomerating compound, the coating layer may optionally comprise one or more compounds chosen from: chemical additives, polymers, etc.

Advantageously, the viscosifying compound and the anti-agglomerating compound represent at least 90% by weight relative to the total weight of the coating layer, even better still at least 95% by weight and advantageously at least 98% by weight.

According to one preferred embodiment, the coating layer essentially consists of the viscosifying compound and of the anti-agglomerating compound.

The Pellets:

According to the invention, the bitumen which is solid at ambient temperature is packaged in a divided form, i.e. in the form of small units, which are called pellets or particles, comprising a bitumen-based core and an envelope or shell or covering or coating layer or coating.

Preferably, the solid bitumen pellets according to the invention may have, within the same population of pellets, one or more shapes chosen from cylindrical, spherical or ovoid. The size of the bitumen pellets is such that the longest average dimension is preferably less than or equal to 50 mm, more preferentially from 3 to 30 mm, even more preferentially between 5 and 20 mm. The size and the shape of the bitumen pellets can vary according to the manufacturing process used. For example, the use of a die makes it possible to control the manufacture of pellets of a chosen size. Sieving makes it possible to select pellets according to their size.

Preferably, the bitumen pellets according to the invention have a weight of between 0.1 and 50 g, preferably between 0.2 and 10 g, more preferentially between 0.2 and 5 g.

Without being bound to theory, the applicant has discovered, unexpectedly, that the combination of a viscosifying compound according to the invention and of an anti-agglomerating compound according to the invention makes it possible to obtain a coating layer:
which withstands the climatic conditions and the conditions for transportation and/or storage of the solid road bitumen,
which breaks easily under a mechanical shear effect, for instance under the effect of a mechanical shear applied in a tank such as a mixer or a mixer drum during the manufacture of mixes.

More particularly, the coating layer withstands the transportation and/or storage of the bitumen at ambient temperature in Big Bags while at the same time being brittle under the effect of a mechanical shear. It thus allows the release of the bitumen core during the manufacture of mixes.

According to one embodiment of the invention, the solid bitumen also comprises one or more other covering layers, based on an anti-agglomerating agent totally or partially covering the coating layer of the solid bitumen according to the invention.

According to one particularly preferred embodiment of the invention, the solid bitumen has:
a core comprising at least one bitumen base, and
a coating layer comprising gelatin or a PEG and at least one anti-agglomerating compound chosen from fines, generally with a diameter of less than 125 μm; wood residues such as lignin, conifer needle powders and conifer cone powders; powdered rubber; powder of SBS copolymers;
and mixtures thereof.

More preferably, the solid bitumen has:
a core comprising at least one bitumen base, and
a coating layer comprising gelatin or a PEG and at least one anti-agglomerating compound chosen from fines generally with a diameter of less than 125 μm; lignin; powdered rubber; powder of SBS copolymers.

According to a more preferred embodiment, the solid bitumen essentially consists of:
a core consisting of a bitumen base, and
a coating layer consisting of a mixture of gelatin, or of a PEG, with at least one anti-agglomerating compound chosen from fines generally with a diameter of less than 125 μm; lignin; powdered rubber; powder of SBS copolymers.

According to one advantageous embodiment, the solid bitumen essentially consists of:
a core consisting of a bitumen base comprising a chemical additive and
a coating layer consisting of a mixture of gelatin, or of a PEG, with at least one anti-agglomerating compound chosen from fines generally with a diameter of less than 125 μm; lignin; powdered rubber; powder of SBS copolymers.

According to another more preferred embodiment, the solid bitumen essentially consists of:
a core consisting of a bitumen base, comprising a chemical additive of formula (I) defined below and
a coating layer consisting of a mixture of gelatin, or of a PEG, with at least one anti-agglomerating compound chosen from fines generally with a diameter of less than 125 μm; lignin; powdered rubber; powder of SBS copolymers.

The Bitumen Base

Advantageously, the nucleus or the core of the pellets of solid bitumen according to the invention is prepared from road bitumen, said road bitumen being prepared by bringing into contact:
one or more bitumen bases, and
optionally at least one chemical additive.

For the purposes of the invention, the terms “bitumen” and “road bitumen” are used in an equivalent manner and independently of one another. The term “bitumen” or “road bitumen” is intended to mean any bituminous compositions consisting of one or more bitumen bases and optionally comprising one or more chemical additives, said compositions being intended for a road application.

Among the bitumen bases that can be used according to the invention, mention may be made first of all of bitumens of natural origin, those contained in natural bitumen or natural asphalt deposits or bituminous sands and bitumens originating from the refining of crude oil. The bitumen bases according to the invention are advantageously chosen from bitumen bases originating from the refining of crude oil. The bitumen bases may be chosen from bitumen bases or mixtures of bitumen bases originating from the refining of crude oil, in particular bitumen bases containing asphaltines or pitch. The bitumen bases can be obtained by conventional processes for manufacturing bitumen bases in refining, in particular by direct distillation and/or vacuum distillation of oil. These bitumen bases can optionally be visbroken and/or deasphalted and/or air-rectified. It is common practice to vacuum-distillate the atmospheric residues originating from the atmospheric distillation of crude oil. This manufacturing process consequently corresponds to the sequence of an atmospheric distillation and a vacuum distillation, the feedstock feeding the vacuum distillation corresponding to the atmospheric residues. These vacuum residues from the vacuum-distillation tower can also be used as bitumens. It is also common practice to inject air into a feedstock usually composed of distillates and heavy products originating from the vacuum distillation of atmospheric residues originating from the distillation of oil. This process makes it possible to obtain a blown, or semi-blown or oxidized or air-rectified or partially air-rectified base.

The various bitumen bases obtained by means of refining processes can be combined with one another to obtain the best technical compromise. The bitumen base may also be a bitumen base from recycling. The bitumen bases may be bitumen bases of hard grade or of soft grade.

According to the invention, for the conventional processes for manufacturing the bitumen bases, they are carried out at manufacturing temperatures of between 100° C. and 200° C., preferably between 140° C. and 200° C., more preferentially between 140° C. and 170° C., and with stirring for a period of at least 10 minutes, preferably at between 30 minutes and 10 hours, more preferentially between 1 hour and 6 hours. The term “manufacturing temperature” is intended to mean the temperature to which the bitumen base(s) is (are) heated before mixing and also the mixing temperature. The heating temperature and time vary according to the amount of bitumen used and are defined by standard NF EN 12594.

According to the invention, blown bitumens can be manufactured in a blowing unit, by passing a stream of air and/or of oxygen through a starting bituminous base. This operation can be carried out in the presence of an oxidation catalyst, for example phosphoric acid. Generally, the blowing is carried out at high temperatures, of about 200 to 300° C., for relatively long periods of time, typically of between 30 minutes and 2 hours, continuously or batchwise. The blowing time and temperature are adjusted according to the properties targeted for the blown bitumen and according to the quality of the starting bitumen.

Preferentially, the bitumen base used to manufacture the pellets of the invention has a needle-penetrability measured at 25° C. according to standard EN 1426 of from 5 to 330 1/10 mm, preferably from 20 to 220 1/10 mm.

In a known manner, the “needle-penetrability” measurement is carried out by means of a standardized test NF EN 1426 at 25° C. (P₂₅). This penetrability characteristic is expressed in tenths of a millimetre (dmm or 1/10 mm). The needle-penetrability, measured at 25° C., according to the standardized test NF EN 1426, represents the measurement of the penetration into a bitumen sample, after a time of 5 seconds, of a needle of which the weight with its support is 100 g. The standard NF EN 1426 represents the approved standard NF T 66-004 from December 1986 with effect on Dec. 20, 1999 (decision of the Directorate General of AFNOR of Nov. 20, 1999).

The Chemical Additive

The bitumen base may also comprise at least one chemical additive chosen from: an organic compound, a paraffin, a phosphoric acid and mixtures thereof.

In particular, when the solid bitumen comprises at least one chemical additive, the penetrability targeted for the additivated bitumen base is preferably from 5 to 45 1/10 mm and/or the ring and ball softening temperature (RBT) targeted is preferably greater than or equal to 90° C., it being understood that the penetrability is measured at 25° C. according to standard EN 1426 and the RBT according to standard EN 1427.

According to a first embodiment of the invention, the chemical additive is an organic compound. Advantageously, the organic compound has a molar mass of less than or equal to 2000 gmol⁻¹, preferably a molar mass of less than or equal to 1000 gmol.

In this first embodiment, according to a first variant, the organic compound is a compound of general formula (I):

Ar1-R-Ar2 (I),

in which:
Ar1 and Ar2 represent, independently of one another, a benzene nucleus or a system of fused aromatic nuclei having from 6 to 20 carbon atoms, substituted with at least one hydroxyl group, and
R represents an optionally substituted divalent radical, the principal chain of which comprises from 6 to 20 carbon atoms and at least one group chosen from amide, ester, hydrazide, urea, carbamate and anhydride functions.

Preferably, Ar1 and/or Ar2 are substituted with at least one alkyl group having 1 to 10 carbon atoms, advantageously in one or more (ortho) positions with respect to the hydroxyl group(s), more preferentially Ar1 and Ar2 are 3,5-dialkyl-4-hydroxyphenyl groups, advantageously 3,5-di-tert-butyl-4-hydroxyphenyl groups.

Preferably, R is in the para position with respect to a hydroxyl group of Ar1 and/or Ar2.

Advantageously, the compound of formula (I) is 2′,3-bis[(3-[3,5-di-tert-butyl-4-hydroxyphenyl]propionyl)]propionohydrazide.

According to a second variant of this first embodiment, the organic compound is a compound of general formula (II):

R—(NH)ₙCONH—(X)ₘ—NHCO(NH)ₙ—R′ (II),

in which:
the R and R′ groups, which may be identical or different, contain a saturated or unsaturated, linear, branched or cyclic, optionally substituted hydrocarbon-based chain comprising from 1 to 22 carbon atoms and optionally comprising heteroatoms, rings and/or heterocycles;
the X group contains a saturated or unsaturated, linear, cyclic or branched, optionally substituted hydrocarbon-based chain comprising from 1 to 22 carbon atoms and optionally comprising heteroatoms, rings and/or heterocycles;
n and m are integers having a value from 0 to 1, independently of one another.

According to this variant, when the integer m has a value of 0, then the R—(NH)ₙCONH and NHCO(NH)ₙ—R′ groups are covalently bonded by a hydrazide bond CONH—NHCO. The R group, or the R′ group, then comprises at least one group chosen from: a hydrocarbon-based chain having at least 4 carbon atoms, an aliphatic ring having from 3 to 8 atoms, and an aliphatic, partially aromatic or entirely aromatic, fused polycyclic system, each ring comprising 5 or 6 atoms.

Still according to this variant, when the integer m has a value of 1, then the R group, the R′ group and/or the X group comprises at least one group chosen from: a hydrocarbon-based chain having at least 4 carbon atoms, an aliphatic ring having from 3 to 8 atoms, and an aliphatic, partially aromatic or entirely aromatic, fused polycyclic system, each ring comprising 5 or 6 atoms.

Preferably, the R and/or R′ group comprises an aliphatic hydrocarbon-based chain having from 4 to 22 carbon atoms, in particular chosen from C₄H₉, C₅H₁₁, C₉H₁₉, C₁₁H₂₃, C₁₂H₂₅, C₁₇H₃₅, C₁₈H₃₇, C₂₁H₄₃ and C₂₂H₄₅ groups.

Preferably, the X group represents a saturated, linear hydrocarbon-based chain comprising from 1 to 22 carbon atoms. Preferably, the X group is chosen from C₂H₄ and C₃H₆ groups.

Preferably, the X group may also be a cyclohexyl group or a phenyl group, the R—(NH)ₙCONH— and NHCO(NH)ₙ—R′— radicals may then be in the ortho, meta or para position. Moreover, the R—(NH)ₙCONH— and NHCO(NH)ₙ—R′— radicals may be in the cis or trans position with respect to one another. Furthermore, when the X radical is cyclic, this ring may be substituted with groups other than the two main groups R—(NH)ₙCONH— and NHCO(NH)ₙ—R′—.

Preferably, the X group comprises two rings of 6 carbons linked by a CH₂ group, these rings being aliphatic or aromatic. In this case, the X group is a group comprising two aliphatic rings linked by a CH₂ group which is optionally substituted, for instance:

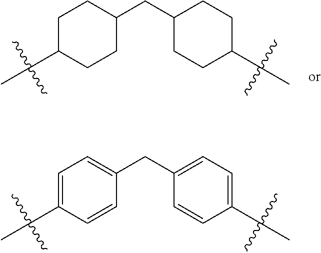 [SMILES: *C1CCC(CC2CCC(*)CC2)CC1 ; *c1ccc(Cc2ccc(*)cc2)cc1]

Advantageously, according to this variant, the organic compound is a compound of general formula (II) chosen from hydrazide derivatives such as the compounds C₅H₁₁—CONH—NHCO—C₅H₁₁, C₉H₁₉—CONH—NHCO—C₉H₁₉, C₁₁H₂₃—CONH—NHCO—C₁₁H₂₃, C₁₇H₃₅—CONH—NHCO—C₇H₃₅, or C₂₁H₄₃—CONH—NHCO—C₂₁H₄₃; diamides such as N,N′-ethylenedi(stearamide) of formula C₁₇H₃₅—CONH—CH₂—CH₂—NHCO—C₁₇H₃₅; and ureide derivatives such as 4,4′-bis(dodecylaminocarbonylamino)-diphenylmethane of formula C₁₂H₂₅—NHCONH—C₆H₄—CH₂—C₆H₄—NHCONH—C₁₂H₂₅.

According to a third variant of this embodiment, the organic compound is a compound of formula (III):

(R—NHCO)ₓ—Z—(NHCO—R′)_{y} (III),

in which:
R and R′, which may be identical or different, contain a saturated or unsaturated, linear, branched or cyclic, optionally substituted hydrocarbon-based chain comprising from 1 to 22 carbon atoms and optionally comprising heteroatoms, rings and/or heterocycles,
Z represents a trifunctionalized group chosen from the following groups:

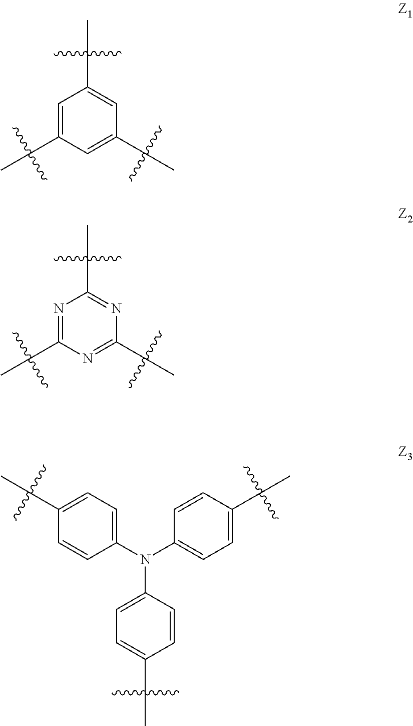 [SMILES: *c1cc(*)cc(*)c1 ; *c1nc(*)nc(*)n1 ; *c1ccc(N(c2ccc(*)cc2)c2ccc(*)cc2)cc1]

x and y are different integers having a value ranging from 0 to 3 and such that x+y=3.

Preferably, when x is equal to 0 and Z represents Z₂, the compound of formula (III) is N2,N4,N6-tridecylmelamine having the formula below with R′ representing the C₉H₁₉ group:

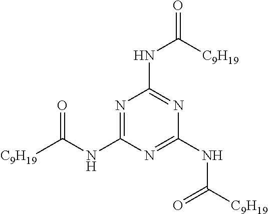

Other preferred compounds corresponding to formula (III) are such that x is equal to 0, Z represents Z₂ and R′ represents a saturated, linear hydrogen-based chain having from 1 to 22 carbon atoms, preferably from 2 to 18 carbon atoms, preferably from 5 to 12 carbon atoms.

Other preferred compounds corresponding to formula (III) are such that: y is equal to 0 and Z represents Z₁, the compounds then have the formula:

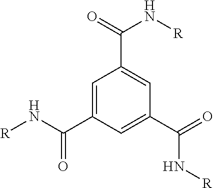

with R chosen from the following groups, taken alone or as mixtures:

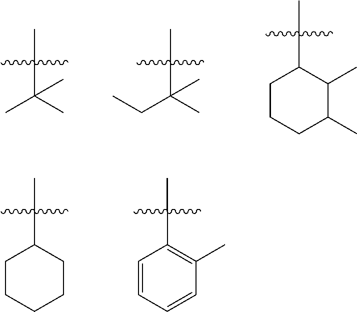

Other preferred compounds corresponding to formula (III) are such that: y is equal to 0, Z represents Z₁ and R represents a saturated, linear hydrocarbon-based chain having from 1 to 22 carbon atoms, preferably from 8 to 12 carbon atoms.

According to a fourth variant of this embodiment, the organic compound is a product of reaction of at least one C₃-C₁₂ polyol and of at least one C₂-C₁₂ aldehyde.

Among the polyols that can be used, mention may be made of sorbitol, xylitol, mannitol and/or ribitol. Preferably, the polyol is sorbitol.

Advantageously, according to this variant, the organic compound is a compound which comprises at least one function of general formula (IV):

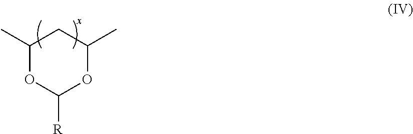

wherein:
x is an integer,
R is chosen from a C₁-C₁₁ alkyl, alkenyl, aryl or aralkyl radical, optionally substituted with one or more halogen atoms, or one or more C₁-C₆ alkoxy groups.

The organic compound is advantageously a sorbitol derivative. The term “sorbitol derivative” is intended to mean any reaction product obtained from sorbitol; in particular any reaction product obtained by reacting an aldehyde with D-sorbitol. Sorbitol acetals, which are sorbitol derivatives, are obtained by means of this condensation reaction. 1,3:2,4-di-O-benzylidene-D-sorbitol is obtained by reacting 1 mol of D-sorbitol and 2 mols of benzaldehyde and has the formula:

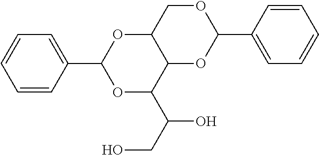 [SMILES: OCC(O)C1OC(c2ccccc2)OC2COC(c3ccccc3)OC21]

The sorbitol derivatives may thus be any of the products of condensation of aldehydes, in particular of aromatic aldehydes with sorbitol. Sorbitol derivatives of general formula:

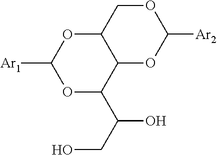

wherein Ar₁ and Ar₂ are optionally substituted aromatic nuclei, will then be obtained.

Among the sorbitol derivatives, other than 1,3:2,4-di-O-benzylidene-D-sorbitol, may be for example 1,3:2,4:5,6-tri-O-benzylidene-D-sorbitol, 2,4-mono-O-benzylidene-D-sorbitol, 1,3:2,4-bis(p-methylbenzylidene) sorbitol, 1,3:2,4-bis(3,4-dimethylbenzylidene) sorbitol, 1,3:2,4-bis(p-ethylbenzylidene) sorbitol, 1,3:2,4-bis(p-propylbenzylidene) sorbitol, 1,3:2,4-bis(p-butylbenzylidene) sorbitol, 1,3:2,4-bis(p-ethoxybenzylidene) sorbitol, 1,3:2,4-bis(p-chlorobenzylidene) sorbitol, 1,3:2,4-bis(p-bromobenzylidene) sorbitol, 1,3:2,4-di-O-methylbenzylidene-D-sorbitol, 1,3:2,4-di-O-dimethylbenzylidene-D-sorbitol, 1,3:2,4-di-O-(4-methylbenzylidene)-D-sorbitol and 1,3:2,4-di-O-(4,3-dimethylbenzylidene)-D-sorbitol. Preferably, according to this variant, the organic compound is 1,3:2,4-di-O-benzylidene-D-sorbitol.

According to a fifth variant of this embodiment, the organic compound is a compound of general formula (V):

R″—(COOH)_{z} (V)

in which R″ represents a saturated or unsaturated, linear or branched chain comprising from 4 to 68 carbon atoms, preferably from 4 to 54 carbon atoms, more preferentially from 4 to 36 carbon atoms, and z is an integer ranging from 2 to 4.

Preferably, the R″ group is preferably a saturated linear chain of formula C_{w}H_{2w} with w an integer ranging from 4 to 22, preferably from 4 to 12.

According to this variant of the invention, the organic compounds corresponding to formula (V) may be diacids (z=2), triacids (z=3) or tetraacids (z=4). The organic compounds which are preferred according to this variant are diacids with z=2.

Preferably, according to this variant, the diacids have the general formula HOOC—C_{w}H_{2w}—COOH with w an integer ranging from 4 to 22, preferably from 4 to 12, and wherein z=2 and R″=C_{w}H_{2w}.

Advantageously, according to this variant, the organic compound is a diacid chosen from adipic acid or 1,6-hexanedioic acid with w=4, pimelic acid or 1,7-heptanedioic acid with w=5, suberic acid or 1,8-octanedioic acid with w=6, azeleic acid or 1,9-nonanedioic acid with w=7, sebacic acid or 1,10-decanedioic acid with w=8, undecanedioic acid with w=9, 1,2-dodecanedioic acid with w=10 or tetradecanedioic acid with w=12.

The diacids may also be diacid dimers of unsaturated fatty acid(s), i.e. dimers formed from at least one unsaturated fatty acid, for example from a single unsaturated fatty acid or from two different unsaturated fatty acids. The diacid dimers of unsaturated fatty acid(s) are conventionally obtained by intermolecular dimerization reaction of at least one unsaturated fatty acid (Diels Alder reaction for example).

Preferably, a single type of unsaturated fatty acid is dimerized. They derive in particular from the dimerization of an unsaturated fatty acid which is in particular C₈ to C₃₄, in particular C₁₂ to C₂₂, in particular C₁₂ to C₂₀, and more particularly C₁₈. A preferred fatty acid dimer is obtained by dimerization of linoleic acid, it being possible for the acid to be subsequently partially or totally hydrogenated. Another preferred fatty acid dimer has the formula HOOC—(CH₂)₇—CH═CH—(CH₂)₇—COOH. Another preferred fatty acid dimer is obtained by dimerization of methyl linoleate. In the same way, it is possible to have fatty acid triacids and fatty acid tetraacids, obtained respectively by trimerization and tetramerization of at least one fatty acid.

According to a sixth variant of this embodiment, the organic compound is a compound of general formula (VI):

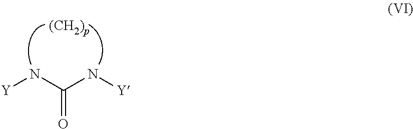

in which:
the Y and Y′ groups represent, independently of one another, an atom or group chosen from: H, —(CH₂)q-CH₃, —(CH₂)q-NH₂, —(CH₂)q-OH, —(CH₂)q-COOH or

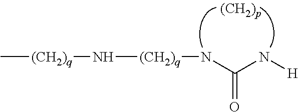

with q an integer ranging from 2 to 18, preferably from 2 to 10, preferably from 2 to 4 and p an integer greater than or equal to 2, preferably having a value of 2 or 3.

Among the preferred organic compounds corresponding to formula (VI), mention may be made of the following compounds:

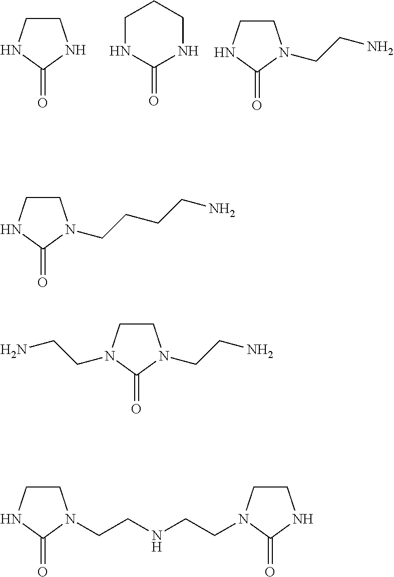 [SMILES: O=C1NCCN1 ; O=C1NCCCN1 ; NCCN1CCNC1=O ; NCCCCN1CCNC1=O ; NCCN1CCN(CCN)C1=O ; O=C1NCCN1CCNCCN1CCNC1=O]

Preferably, according to this variant, the organic compound of general formula (VI) is:

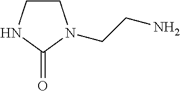

According to a seventh variant of this embodiment, the organic compound is a compound of general formula (VII):

R—NH—CO—CO—NH—R′ (VII)

in which R and R′, which may be identical or different, represent a saturated or unsaturated, linear, branched or cyclic, optionally substituted hydrocarbon-based chain comprising from 1 to 22 carbon atoms, preferably from 8 to 12 carbon atoms, and optionally comprising heteroatoms, rings and/or heterocycles.

According to another embodiment of the invention, the chemical additive is a paraffin. The paraffins have chain lengths of 30 to 120 carbon atoms (C₃₀ to C₁₂₀). The paraffins are advantageously chosen from polyalkylenes. Preferably, polymethylene paraffins and polyethylene paraffins will be used according to the invention. These paraffins may be of petroleum origin or may originate from the chemical industry. Advantageously, the paraffins used are synthetic paraffins resulting from the conversion of biomass and/or natural gas.

Preferably, these paraffins contain a large proportion of “normal” paraffins, i.e. unbranched, straight-chain linear paraffins (saturated hydrocarbons). Thus, the paraffins may comprise from 50% to 100% of normal paraffins and from 0 to 50% of isoparaffins and/or of branched paraffins. More preferentially, the paraffins comprise from 85% to 95% of normal paraffins and from 5% to 15% of isoparaffins and/or of branched paraffins. Advantageously, the paraffins comprise from 50% to 100% of normal paraffins and from 0 to 50% of isoparaffins. Even more advantageously, the paraffins comprise from 85% to 95% of normal paraffins and from 5% to 15% of isoparaffins.

Preferably, the paraffins are polymethylene paraffins. More particularly, the paraffins are synthetic polymethylene paraffins, for example paraffins resulting from the conversion of syngas by the Fischer-Tropsch process. In the Fischer-Tropsch process, the paraffins are obtained by reacting hydrogen with carbon monoxide on a metal catalyst. Fischer-Tropsch synthesis processes are described, for example, in the publications EP 1 432 778, EP 1 328 607 or EP 0 199 475.

According to another embodiment of the invention, the chemical additive is a polyphosphoric acid. The polyphosphoric acids (PPAs) that can be used in the invention are described in WO 97/14753. They are compounds of empirical formula P_{q}HᵣOₛ in which q, r and s are positive integers such that:

q≥2 and in particular q ranges from 3 to 20 or more and that 5q+r−2s=0.

In particular, said polyphosphoric acids may be linear compounds of empirical formula P_{q}H_{(q+2)}O_{(3q+1)} corresponding to the structural formula:

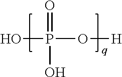

wherein q has the definition given above. They may also be products of two-dimensional or three-dimensional structure.

All these polyphosphoric acids can be considered to be products of polycondensation by heating aqueous metaphosphoric acid.

Combining several different chemical additives such as various organic compounds of formulae (I), (II), (III), (V), (VI) and (VII), the products of reaction of at least one C₃-C₁₂ polyol and of at least one C₂-C₁₂ aldehyde, in particular those comprising a group of formula (IV) and/or various paraffins and/or various polyphosphoric acids in the bitumen base will not be a departure from the invention.

According to one embodiment of the invention, the bitumen base of which the core of the pellets is composed comprises from 0.1% to 10% by weight, preferably from 0.5% to 5% by weight, more preferentially from 0.5% to 2.5% by weight, of chemical additive relative to the total weight of said core.

According to one embodiment of the invention, the core may also comprise at least one olefinic polymer adjuvant.

The olefinic polymer adjuvant is preferably chosen from the group consisting of (a) ethylene/glycidyl (meth)acrylate copolymers; (b) ethylene/monomer A/monomer B terpolymers and (c) copolymers resulting from the grafting of a monomer B onto a polymer substrate.
(a) The ethylene/glycidyl (meth)acrylate copolymers are advantageously chosen from random or block, preferably random, copolymers of ethylene and of a monomer chosen from glycidyl acrylate and glycidyl methacrylate, comprising from 50% to 99.7% by weight, preferably from 60% to 95% by weight, more preferentially from 60% to 90% by weight of ethylene.
(b) The terpolymers are advantageously chosen from random or block, preferably random, terpolymers of ethylene, of a monomer A and of a monomer B. The monomer A is chosen from vinyl acetate and C₁ to C₆ alkyl acrylates or methacrylates.
   The monomer B is chosen from glycidyl acrylate and glycidyl methacrylate. The ethylene/monomer A/monomer B terpolymers comprise from 0.5% to 40% by weight, preferably from 5% to 35% by weight, more preferentially from 10% to 30% by weight of units derived from the monomer A, and from 0.5% to 15% by weight, preferably from 2.5% to 15% by weight of units derived from the monomer B, the rest being formed from units derived from ethylene.
(c) The copolymers result from the grafting of a monomer B, chosen from glycidyl acrylate and glycidyl methacrylate, onto a polymer substrate. The polymer substrate consists of a polymer chosen from polyethylenes, in particular low-density polyethylenes, polypropylenes, random or block, preferably random, copolymers of ethylene and of vinyl acetate, and random or block, preferably random, copolymers of ethylene and of C₁ to C₈ alkyl acrylate or methacrylate, comprising from 40% to 99.7% by weight, preferably from 50% to 99% by weight of ethylene. Said grafted copolymers comprising from 0.5% to 15% by weight, preferably from 2.5% to 15% by weight of grafted units derived from the monomer B.

Advantageously, the olefinic polymer adjuvant is chosen from random terpolymers of ethylene (b), of a monomer A chosen from C₁ to C₆ alkyl acrylates or methacrylates and of a monomer B chosen from glycidyl acrylate and glycidyl methacrylate, comprising from 0.5% to 40% by weight, preferably from 5% to 35% by weight, more preferentially from 10% to 30% by weight of units derived from the monomer A, and from 0.5% to 15% by weight, preferably from 2.5% to 15% by weight of units derived from the monomer B, the rest being formed from units derived from ethylene.

According to one embodiment of the invention, the bitumen base of which the core of the pellets is composed comprises from 0.05% to 15% by weight, preferably from 0.1% to 10% by weight, more preferentially from 0.5% to 6% by weight of the olefinic polymer adjuvant relative to the total weight of said core.

According to one embodiment of the invention, the nucleus may also comprise other known additives or other known elastomers for bitumen, such as the copolymers SB (copolymer comprising styrene and butadiene blocks), SBS (copolymer comprising styrene-butadiene-styrene blocks), SIS (styrene-isoprene-styrene), SBS* (star copolymer comprising styrene-butadiene-styrene blocks), SBR (styrene-b-butadiene-rubber) or EPDM (ethylene propylene diene modified). These elastomers may also be crosslinked according to any known process, for example with sulfur. Mention may also be made of elastomers produced from styrene monomers and from butadiene monomers allowing crosslinking without crosslinking agent, as described in documents WO 2007/058994 and WO 2008/137394 and by the applicant in patent application WO 11/013073.

Process for Manufacturing the Pellets:

Another subject of the invention relates to a process for manufacturing a bitumen which is solid at ambient temperature, in the form of pellets composed of a core and of a coating layer for the core, this process comprising:
i) forming the core from at least one bitumen base,
ii) coating the core on all or part of its surface with a composition comprising at least one viscosifying compound and at least one anti-agglomerating compound,
iii) optionally, drying the pellets obtained in step ii) at a temperature ranging from 20 to 60° C., for a period ranging from 5 minutes to 5 hours, preferably from 5 minutes to 2 hours.

Preferably, the application step ii) is carried out by dipping, spraying, co-extrusion, etc.

The forming of the core of the pellets from an optionally additivated bitumen base can be carried out according to any known process, for example according to the manufacturing process described in document U.S. Pat. No. 3,026,568, document WO 2009/153324 or document WO 2012/168380. According to one particular embodiment, the forming of the core of the solid bitumen can be carried out by draining, in particular using a drum.

Other techniques can be used in the process for manufacturing the core of the solid bitumen, in particular molding, pelletizing, extrusion, etc.

Preferably, the solid-bitumen core particles have a longest average dimension ranging from 1 to 30 mm, advantageously from 5 to 20 mm.

Preferably, during the implementing of the process of the invention, the weight ratio of the coating composition comprising at least one viscosifying compound and at least one anti-agglomerating compound relative to the weight of optionally additivated bitumen base forming the core is from 0.1 to 1, advantageously from 0.2 to 0.9.

Another subject of the invention is a bitumen which is solid at ambient temperature, in the form of pellets which can be obtained by carrying out the process according to the invention as described above. Such a solid bitumen in the form of pellets advantageously has the properties described above.

Use of the Pellets of Solid Bitumen:

Another subject of the invention also relates to the use of the pellets of bitumen which is solid at ambient temperature according to the invention as described above, as a road binder.

The road binder can be used to manufacture mixes, in combination with aggregates according to any known process.

Preferably, the bitumen which is solid at ambient temperature according to the invention is used for manufacturing mixes.

The bituminous mixes are used as materials for the construction and maintenance of road foundations and their surfacing, and also for carrying out all roadworks. Mention may, for example, be made of surface coatings, hot mixes, cold mixes, cold-poured mixes, grave emulsions, base layers, bond layers, tie layers and running layers, and other combinations of a bituminous binder and of the road aggregate having particular properties, such as anti-rutting layers, draining mixes, or asphalts (mixture between a bituminous binder and aggregates of the sand type).

Another subject of the invention relates to a process for manufacturing mixes comprising at least one road binder and aggregates, the road binder being chosen from the bitumens according to the invention, this process comprising at least the steps of:
heating the aggregates to a temperature ranging from 100° C. to 180° C., preferably from 12000 to 160° C.,
mixing the aggregates with the road binder in a tank such as a mixer or a mixing drum,
obtaining mixes.

The process of the invention has the advantage of being able to be carried out without a prior step of heating the pellets of solid bitumen.

The process for manufacturing mixes according to the invention does not require a step of heating the pellets of solid bitumen before mixing with the aggregates since, on contact with the hot aggregates, the bitumen which is solid at ambient temperature melts.

The bitumen which is solid at ambient temperature according to the invention as described above has the advantage of being able to be added directly to the hot aggregates, without having to be melted prior to the mixing with the hot aggregates.

Preferably, the step of mixing the aggregates and the road binder is carried out with stirring, and the stirring is maintained for at most 5 minutes, preferably at most 1 minute, in order to allow a homogeneous mixture to be obtained.

The solid bitumen in the form of pellets according to the present invention is notable in that it allows the transportation and/or storage of road bitumen at ambient temperature under optimal conditions, in particular without there being any agglomeration and/or adhesion of the solid bitumen during transportation thereof and/or storage thereof, even when the ambient temperature is high. Moreover, the coating layer of the pellets breaks under the effect of the contact with the hot aggregates and of the shear and it releases the bitumen base. Finally, the presence of the coating layer in the mixture of road binder and aggregates does not degrade the properties of said road bitumen for a road application, compared with an uncoated bitumen base.

Process for Transportation and/or Storage and/or Handling of Road Bitumen

Another subject of the invention also relates to a process for transportation and/or storage and/or handling of road bitumen, said road bitumen being transported and/or stored and/or handled in the form of bitumen pellets which are solid at ambient temperature.

Preferably, the road bitumen is transported and/or stored at a high ambient temperature for a period of greater than or equal to 2 months, preferably greater than or equal to 3 months.

Preferably, the high ambient temperature is from 20° C. to 90° C., preferably from 20° C. to 80° C., more preferentially from 40° C. to 80° C., even more preferentially from 40° C. to 60° C.

The bitumen pellets according to the invention have the advantage of retaining their divided form, and therefore of being able to be handled, after storage and/or transportation at a high ambient temperature. They in particular have the capacity to flow under their own weight without creeping, thereby making it possible to store them in packaging in bags, in barrels or in containers of any shape and of any volume and then to transfer them from this packaging to a piece of equipment, such as a piece of construction site equipment (tank, mixer, etc).

The bitumen pellets are preferably transported and/or stored in bulk in bags of from 1 kg to 100 kg, or from 500 kg to 1000 kg commonly called, in the road bitumen field, “Big Bags”, said bags preferably being made of hot-melt material. They may also be transported and/or stored in bulk in cartons of from 5 kg to 30 kg or in barrels of from 100 kg to 200 kg.

The various embodiments, variants, preferences and advantages described above for each of the subjects of the invention apply to all the subjects of the invention and can be taken separately or in combination.

The invention is illustrated by the following examples given in a nonlimiting manner.

### Examples

### Materials and Methods

The rheological and mechanical characteristics of the bitumens to which reference is made in these examples are measured in the manner indicated in table 1.

TABLE 1

| | | | Measurement |
|---|---|---|---|
| Property | Abbreviation | Unit | standard |
| Needle-penetrability at 25° C. | P₂₅ | 1/10 mm | NF EN 1426 |
| Ring and ball softening | RBT | ° C. | NF EN 1427 |
| temperature | | | |

The variation in the ring and ball softening temperature (RBT) of said composition is measured according to standard NF EN 1427 between the sample extracted from the top part of the sample tube and the sample extracted from the bottom part of the sample tube.

The bitumen bases B₂ to B₅ are prepared from:
a bitumen base of 35150 grade, denoted B₁, having a penetrability P₂₅ of 34 1/10 mm and an RBT of 52.6° C. and commercially available from the group Total under the brand name Azalt®;
a styrene/butadiene/styrene (SBS) block copolymer, containing 30.5% by weight of styrene and 69.5% by weight of butadiene. The content of 1,2-vinyl group is 27.8% by weight relative to the total weight of copolymer. The copolymer has a weight-average molecular weight (Mw) of 142 500 daltons and a polydispersity index Iₚ of 1.09. This copolymer is commercially available from the company Kraton under the name D1192;
a chemical additive, 2′,3-bis[[3-[3,5-di-tert-butyl-4-hydroxyphenyl]propionyl]]propionohydrazide, denoted hydrazide;
1,10-decanoic acid, denoted acid;
flower of sulfur, denoted crosslinker;
zinc octanoate; denoted scavenger.

The weight percentage amounts used for each bitumen are indicated in table 2 below.

TABLE 2

| Bitumen | B₂ | B₃ | B₄ | B₅ |
|---|---|---|---|---|
| Bitumen base B₁ | 99.1% | 98.5% | 95.4% | 94.8% |
| Hydrazide | 0.9% | — | 0.9% | — |
| Acid | — | 1.5% | — | 1.5% |
| SBS | — | — | 3.4% | 3.4% |
| Crosslinker | — | — | 0.1 | 0.1 |
| Scavenger | — | — | 0.2 | 0.2 |
| P25 (1/10 mm) | 17 | 14 | 22 | 21 |
| RBT (° C.) | 107 | 93 | 34 | 37 |

The amount of additives for each bitumen is adjusted so as to obtain bitumens having equivalent mechanical properties, in particular a similar penetrability P₂₅ and a similar RBT.

The bitumens are prepared in the following way.

For the bitumen B₂, the bitumen base B₁ is introduced into a reactor maintained at 160° C. with stirring at 300 revolutions/min for two hours. The hydrazide is then introduced into the reactor. The content of the reactor is maintained at 160° C. with stirring at 300 revolutions/min for 1 hour.

The bitumen B₃ is prepared from the bitumen base B₁ and the acid in the same way as the bitumen B₂.

For the bitumen B₄, the bitumen base B₁ and the SBS copolymer are introduced into a reactor maintained at 185° C. and with stirring at 300 revolutions/min. The content of the reactor is then maintained at 185° C. with stirring at 300 revolutions/min for 4 hours. 0.1% of crosslinker is added, the mixture is left to react for 2 h at 185° C. with stirring at 300 revolutions/min and 0.2% of scavenger is added at 185° C. with stirring at 300 revolutions/min for 20 min. The temperature is reduced to 160° C. with stirring at 300 revolutions/min, then the hydrazide is added in the form of pellets. The mixture is stirred for approximately 1 hour at 160° C. so as to obtain a final homogeneous appearance. The mixture is cooled to ambient temperature.

The bitumen B₅ is prepared like the bitumen B₄ using acid in the place of the hydrazide.

1. Preparation of the various pellets of solid bitumens G₁, G₂, G₃, G₄, G₅, G₆, G₇, G₈, G₉ and G₁₀

### 1.1 General Method for Preparing the Bitumen Cores of the Pellets According to the Invention

The bitumen base (B₂ to B₅) is reheated at 160° C. for two hours in an oven before being poured into a silicone mold having various spherically shaped holes so as to form the cores of solid bitumen. After having noted the solidification of the bitumen in the mold, the surplus is leveled off with a blade heated on a Bunsen burner. After 30 minutes, the solid bitumen in the form of uncoated pellets is removed from the mold and stored in a tray covered with siliconized paper. The bitumen cores are then left to cool to ambient temperature for 10 to 15 minutes.

### 1.2 General Method for Preparing the Pellets of Solid Bitumen According to the Invention Comprising a Coating Layer (PEG-4000 and Lignin)

A composition is prepared by melting PEG-4000 in an oven at a temperature of between 70° C. and 80° C. for a period of between one and two hours. The lignin is added while hot to this composition, with stirring.

The bitumen cores previously obtained in 1.1 are pricked onto a needle before being immersed in the coating composition, still in the oven, with stirring.

The coated bitumen pellets are deposited on a silicone plate. Optionally, the coated solid bitumen pellets thus obtained can be coated with an additional layer with the lignin powder.

The solid bitumen pellets thus obtained are left in the open air for at least 2 hours and at ambient temperature in order to solidify the coating layer.

Pellets of solid bitumen with a core/envelope structure according to the invention are thus obtained.

The amounts of PEG-4000 and of lignin can vary according to the desired viscosity of the composition.

A composition C1 was prepared comprising 80% by weight of PEG-4000 and 20% by weight of lignin.

### 1.3 General Method for Preparing the Pellets of Solid Bitumen According to the Invention Comprising a Coating Layer (Gelatin and Lignin) or (Gelatin and Powdered Rubber) or (Gelatin and Styrene-Butadiene-Styrene Copolymer Powder)

The gelatin, in the form of a sheet, is soaked in cold water for 10 minutes until 80% of water has been absorbed, then placed in an oven at 70° C. The lignin, predried at 110° C. for a period of two hours, is added while hot to the gelatin.

The bitumen cores previously obtained in 1.1 are pricked onto a needle before being immersed in the previously obtained coating composition, still in the oven, with stirring.

The coated bitumen pellets are deposited on a silicone plate. Optionally, the coated solid bitumen pellets thus obtained can be coated with an additional layer with the lignin powder.

The coated solid bitumen pellets thus obtained are left in the open air for a few minutes and then are subsequently annealed at 50° C. for a period of between one hour and two hours in order to solidify the coating layer.

Pellets of solid bitumen with a core/envelope structure according to the invention are thus obtained.

The amounts of gelatin, of water and of anti-agglomerating compound can vary according to the desired viscosity of the composition.

The compositions (gelatin and lignin or powdered rubber or SBS copolymer powder) C2, C3, C4, C5 and C6 were prepared according to table 3.

TABLE 3

| | Gelatin | | Powdered | | |
|---|---|---|---|---|---|
| | (% by | Lignin (% by | rubber (% by | SBS powder | Water (% by |
| | weight) | weight) | weight) | (% by weight) | weight) |
| C2 | 16 | 15 | — | — | 69 |
| C3 | 14 | 13 | — | — | 73 |
| C4 | 11.1 | — | 44.4 | — | 44.5 |
| C5 | 11.1 | — | — | 44.4 | 44.5 |
| C6 | 11.1 | 44.4 | — | — | 44.5 |

### 1.4 Preparation of Various Solid Bitumens According to the Invention

A solid bitumen G₁ (control test) was prepared according to the method described in point 1.1, then powdered with lignin. G₁ is composed of a bitumen core obtained by forming of the base B₂ and of an anti-agglomerating layer composed of filler (fines).

A solid bitumen G₂ (control test) was prepared according to the method described in point 1.1, then powdered with lignin. G₂ is composed of a bitumen core obtained by forming of the base B₂ and of an anti-agglomerating layer composed of lignin.

A solid bitumen G₃ according to the invention was prepared according to the methods described in points 1.1 and 1.2 and is composed of a bitumen core obtained by forming of the base B₃ and of a coating layer obtained from the composition C1.

A solid bitumen G₄ according to the invention was prepared according to the methods described in points 1.1 and 1.3 and is composed of a bitumen core obtained by forming of the base B₃ and of a coating layer obtained from the composition C2.

A solid bitumen G₆ according to the invention was prepared according to the methods described in points 1.1 and 1.3 and is composed of a bitumen core obtained by forming of the base B₃ and of a coating layer obtained from the composition C3.

A solid bitumen G₆ (control test) was prepared according to the method described in point 1.1 and then coated with gelatin. G₆ is composed of a bitumen core obtained by forming of the base B₃ and of an anti-agglomerating layer composed of filler (fines).

A solid bitumen G₇ (control test) was prepared according to the method described in point 1.1 and then coated with gelatin. G₇ is composed of a bitumen core obtained by forming of the base B₃ and of an anti-agglomerating layer composed of lignin.

A solid bitumen G₈ according to the invention was prepared according to the methods described in points 1.1 and 1.3 and is composed of a bitumen core obtained by forming of the base B₃ and of a coating layer obtained from the composition C4.

A solid bitumen G₉ according to the invention was prepared according to the methods described in points 1.1 and 1.3 and is composed of a bitumen core obtained by forming of the base B₃ and of a coating layer obtained from the composition C5.

A solid bitumen G₁₀ according to the invention was prepared according to the methods described in points 1.1 and 1.3 and is composed of a bitumen core obtained by forming of the base B₃ and of a coating layer obtained from the composition C6.

2. Test for Load Resistance of the Solid Bitumens G₁, G₂, G₃, G₄, G₅, G₆, G₇ and G₁₀ in the Form of Coated Pellets

This test is carried out in order to evaluate the load resistance of the pellets G₁ to G₇ and G10 at a temperature of 50° C. under a compressive force. Indeed, this test makes it possible to simulate the conditions of temperature and compression of the pellets on one another to which they are subjected during transportation and/or storage in bulk in bags of from 10 to 100 kg or in Big Bags of from 500 to 1000 kg or in barrels of 200 kg, and to evaluate their resistance under these conditions.

The load resistance test is carried out using a texture analyzer sold under the name LF Plus by the company Lloyd Instruments and equipped with a thermal chamber. To do this, a metal container 25 mm in diameter, containing a weight of 10 g of bitumen pellets, is placed inside the thermal chamber regulated at a temperature of 50° C. for 1 hour. The piston of the texture analyzer is a cylinder 20 mm in diameter and 60 mm high. The cylindrical piston is, at the start, placed in contact with the upper layer of the pellets. It then moves vertically downward, at a constant speed of 0.5 mm/min, over a calibrated distance of 5 mm, so as to exert a compressive force on all of the pellets placed in the container. After withdrawal of the piston, the compression strength of the pellets is evaluated visually, in particular their appearance and their ability to agglomerate. The observations are listed in table 4 below.

TABLE 4

| | G₁ | G₂ | | | | G₆ | G₇ | |
|---|---|---|---|---|---|---|---|---|
| Pellets | (control) | (control) | G₃ | G₄ | G₅ | (control) | (control) | G₁₀ |
| Load resistance | + | + | ++ | +++ | +++ | +− | +− | +++ |
| at 50° C. | | | | | | | | |

+++: the pellets retain their initial shape and do not adhere to one another.
++: the pellets do not adhere to one another, but no longer have their rounded shape.
+: the pellets adhere slightly to one another.
−: the pellets are quite fused.
−−: the pellets are fused

The pellets G₃, G₄, G₅ and G₁₀ according to the invention exhibit very good load resistance at 50° C. insofar as they do not adhere to one another. In addition the pellets G₄ and G₅ retain their initial shape. The pellets G₃, G₄ and G₅ withstand the compression and temperature conditions well compared with the control pellets G₁, G₂, G₆ and G₇ which will have a tendency to agglomerate when they are transported or stored, in particular at temperatures greater than or equal to 50° C. Thus, the handling of said pellets G₁, G₂, G₆ and G₇ will be more difficult compared with the pellets G₃, G₄ and G₅. In particular, if the bitumen pellets are transported in bags or Big Bags the agglomerated pellets G₁, G₂, G₆ and G₇ have a greater risk of leaking out of the bags or Big Bags, making said bags or Big Bags, which will have a tendency to stick to one another, difficult to handle. The transfer thereof into a piece of construction site equipment may also be difficult owing to their behavior.

### 3. Production of Bituminous Mixes

The mixes are prepared according to the following procedure:

First of all, 4.5 kilos of aggregates were heated at 160° C. and placed in a mixer.

Then, 285 g of pellets of solid bitumen G₁₀ with a gelatin/lignin (20/80) shell were poured onto the aggregates preheated to 160° C.

After mixing for 70 seconds (approximately 10 seconds more compared with a hot binder introduced under the same conditions), the bitumen uniformly coated the aggregates which became shiny and tacky.

### 4. Test of Passive Adhesivity of the Bituminous Mixes Obtained in 3

The passive adhesivity is measured according to a method adapted from standard NFT 66-018 and this measurement is assessed visually.

The mixes obtained in point 3 are immersed in a container filled with water heated to 60° C., for a period of 16 hours.

In parallel, the coatings obtained with the bitumen base B1 according to the process described in point 3 are immersed in a container filled with water heated to 60° C., for a period of 16 hours. After 16 hours, no visual difference between these two types of coatings is observed and the surface is totally covered with the binder (100%).

Consequently, the nature of the shell of the bitumen pellets has no influence on the adhesivity of the mixes produced using these pellets.

### 5. Duriez Test

The mechanical performance levels of the mixes obtained in point 3 are measured by carrying out the Duriez test: determination of the water-sensitivity of bituminous test specimens (also called “water stripping resistance test”) according to standard NF EN 12697-12-B which evaluates the adhesion between the bituminous binder and the aggregates.

The term resistance is defined by:

C_{w}: mean compression strength in kilopascals (kPa) of the “wet” batch.
C_{w} is measured on test specimens stored in water at 18° C. for 7 days.
C_{d}: mean compression strength in kilopascals (kPa) of the “dry” batch.
C_{d} is measured on test specimens stored in air for 7 days at 18° C.

The immersion-compression ratio, i/C, is defined according to the following formula:

i/C=[100×(C_{w}/C_{D})]

The result is satisfactory with an i/C (or r/R) ratio=92.3% with C_{d}=11.1 MPa and C_{w}=10.3 MPa. It is noted that the strength levels are good.

1-17. (canceled)

18. A bitumen which is solid at ambient temperature, in the form of pellets comprising a core and a coating layer in which:
the core comprises at least one bitumen base, and
the coating layer comprises at least one viscosifying compound and at least one anti-agglomerating compound.

19. The bitumen as claimed in claim 18, wherein the viscosifying compound has a dynamic viscosity of greater than or equal to 50 mPa·s⁻¹, the viscosity being a Brookfield viscosity measured at 65° C.

20. The bitumen as claimed in claim 19, wherein the viscosifying compound has a dynamic viscosity of from 50 mPa·s⁻¹ to 550 mPa·s⁻¹, the viscosity being a Brookfield viscosity measured at 65° C.

21. The bitumen as claimed in claim 18, wherein the viscosifying compound is chosen from:
gelling compounds;
polyethylene glycols;
and mixtures of such compounds.

22. The bitumen as claimed in claim 21, wherein the viscosifying compound is chosen from: gelatin, agar-agar, alginates, cellulose derivatives, gellan gums, polyethylene glycols having a molecular weight of between 800 g·mol⁻¹ and 8000 g·mol⁻¹ and mixtures thereof.

23. The bitumen as claimed in claim 18, wherein the coating layer comprises at least 10% by weight of a viscosifying compound relative to the total weight of the coating layer.

24. The bitumen as claimed in claim 23, wherein the coating layer comprises from 10% to 90% by weight of a viscosifying compound, relative to the total weight of the coating layer.

25. The bitumen as claimed in claim 18, wherein the anti-agglomerating compound is chosen from: talc, fines; sand; cement; carbon; wood residues; glass powder; alumina; silica; silica derivatives; plastic powder; and mixtures thereof.

26. The bitumen as claimed in claim 25, wherein the anti-agglomerating compound is chosen from fines with a diameter of less than 125 μm, lignin, conifer needle powders, conifer cone powders, silicates, silicon hydroxides, silicon oxides and mixtures thereof.

27. The bitumen as claimed in claim 18, wherein the coating layer comprises at least 10% by weight of an anti-agglomerating compounds relative to the total weight of the coating layer.

28. The bitumen as claimed in claim 27, wherein the coating layer comprises from 10% to 90% by weight of an anti-agglomerating compound, relative to the total weight of the coating layer.

29. The bitumen as claimed in claim 18, wherein the bitumen base has a needle-penetrability measured at 25° C. according to standard EN 1426 of from 5 to 330 1/10 mm.

30. The bitumen as claimed in claim 29, wherein the bitumen base has a needle-penetrability measured at 25° C. according to standard EN 1426 of from 20 to 220 1/10 mm.

31. The bitumen as claimed in claim 18, wherein the bitumen base also comprises at least one chemical additive chosen from: an organic compound, a paraffin, a polyphosphoric acid and mixtures thereof.

32. The bitumen as claimed in claim 18, wherein the bitumen base has a penetrability of 5 to 45 1/10 mm, measured at 25° C. according to standard EN 1426, and/or a ring and ball softening temperature of greater than or equal to 90° C., the ring and ball softening temperature being measured according to standard EN 1427.

33. The bitumen as claimed in claim 18 which is obtained by a process comprising:
i) forming the core from at least one bitumen base,
ii) coating the core on all or part of its surface with a composition comprising at least one viscosifying compound and at least one anti-agglomerating compound,
iii) optionally, drying the pellets obtained in step ii) at a temperature ranging from 20 to 60° C., for a period ranging from 5 minutes to 5 hours.

34. The bitumen as claimed in claim 18, which has a stability with respect to transportation and storage at a temperature ranging from 20 to 80° C. for a period of greater than or equal to 2 months.

35. A process for manufacturing mixes comprising at least one road binder and aggregates, the road binder being chosen from the bitumens as claimed in claim 18, this process comprising at least the steps of:
heating the aggregates to a temperature ranging from 100° C. to 180° C.,
mixing the aggregates with the road binder in a tank such as a mixer or a mixing drum,
obtaining mixes.

36. The process as claimed in claim 35, which does not comprise a step of heating the road binder before it is mixed with the aggregates.
